(19) United States
(12) Patent Application Publication
(10) Pub. No.: US 2006/0157333 A1
(43) Pub. Date: Jul. 20, 2006

(54) Safety plug that is used to switch power in sequence easily and is composed of main body

(76) Inventor: Han-Ming Lee, Hsin Chu City (TW)

Correspondence Address: Han-Ming Lee, P.O. BOX 7-288, TAIPEI, TW

(21) Appl. No.: 11/036,698

(22) Filed: Jan. 18, 2005

(51) Int. Cl. H01H 9/20

(52) U.S. Cl. 200/334

(57) ABSTRACT

This invention is the structure of a safety plug that is used to switch power in sequence easily and is composed of main body, upper housing, copper strip, flexible conductive strip, a non-conductive switch-gear with a curved block on its lateral side; a conductive curve strip embedded on the same axis of the said switch-gear so that they can rotate simultaneously; and two wires with long- and short-end are compressed tightly on the copper strip and on the wires of the joint point of the flexible conductive strip, respectively. The structure is designed so that when the switch-gear rotates in 360 degrees, the curved block will rotate simultaneously. Two corresponding curved blocks are used to control the rotation in order to connect the curve strip to the front and back conductive strips. There is a gap on the bottom of the curved blocks in order to increase the flexibility factor of the conductive strip's forward and reverse performance. Consequently, this invention is invented for easy power switch in sequence, so as to prevent the loosing plug by eliminating the frequent plug and unplug actions, and the danger of electric shock.

### BACKGROUND OF THE INVENTION

There are many different kinds of electric appliances in our daily life and they have become necessaries to our daily life. Most electric appliances have a plug connected to a socket. Before using an electric appliance, the plug must be plugged into the socket. As far as safety is concerned, the plug must be removed from the socket in order to avoid resource or property loss due to electric leakage. Besides the environment barrier, which makes users inconvenient to insert or remove a plug from the socket, other disadvantages are included as follows:

(1) Frequent plug and unplug actions may cause the plug and the conductive strip of the socket to become loosened and further cause poor conduction.

(2) Incorrect plug and unplug actions may cause the plug and the socket to be worn-out or broken or be more seriously damaged.

(3) The sudden friction between the plug strip and the socket strip may cause sparks during plug and unplug actions, and if the strips are exposed to humidity, it may cause accidents such as static electric shocks.

### SUMMARY OF THE INVENTION

The primary purpose of this invention is to provide the structure of a safety plug that is used to switch power in sequence easily and is composed of main body, upper housing, copper strip, flexible conductive strip, a non-conductive switch-gear with gear tooth around the peripheral of the switch-gear, and a curved block on its lateral side; a conductive curve strip embedded on the same axis of the said switch-gear so that they can rotate simultaneously; and two wires with long- and short-end are compressed tightly on the copper strip and on the wires of the joint point of the flexible conductive strip, respectively. Further, it is to ensure that the plug can provide an efficient power switch device with safety features and excellent conductive quality.

The secondary purpose is to provide the structure of a safety plug that is used to switch power in sequence easily, and of which is designed so that when the switch-gear rotates in 360 degrees, the curved block will rotate simultaneously. Two corresponding curved blocks are used to control the rotation in order to connect the curve strip to the front and back conductive strips. There is a gap on the bottom of the curved blocks in order to increase the flexibility factor of the conductive strip's forward and reverse performance. Consequently, this invention is invented for easy power switch supply in sequence, so as to prevent the loosing plug by eliminating the frequent plug and unplug actions, and the danger of electric shock.

The other purpose of this invention is to provide the structure of a safety plug that is used to switch power supply so that without removing the plug from the socket, the power supply can easily be switched off by rotating the switch-gear on the plug.

### BRIEF DESCRIPTION OF THE DRAWINGS

FIG. 1 is the three-dimensional diagram of this invention, which is the structure of a safety plug that is used to switch power supply in sequence easily;

FIG. 2 is the detailed diagram of the assembly components of this invention, which is the structure of a safety plug that is used to switch power supply in sequence easily;

FIG. 3 is the cutaway view of this invention, which is the structure of a safety plug that is used to switch power supply in sequence easily;

FIG. 4 is the horizontal view of this invention, which is the structure of a safety plug that is used to switch power supply in sequence easily;

FIG. 5 is the diagram of controlling the switching of the curve strip connection of the curved block and flexible conductive strip factor function of this invention.

### DELTAILED DESCRIPTION OF THE PREFERRED EMBODIMENT

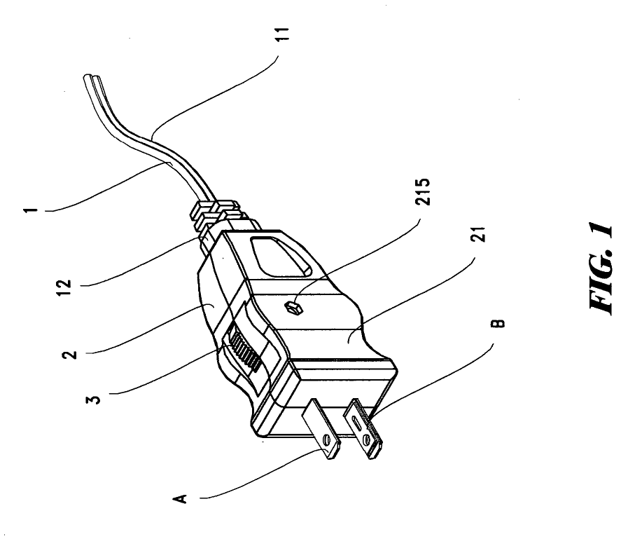

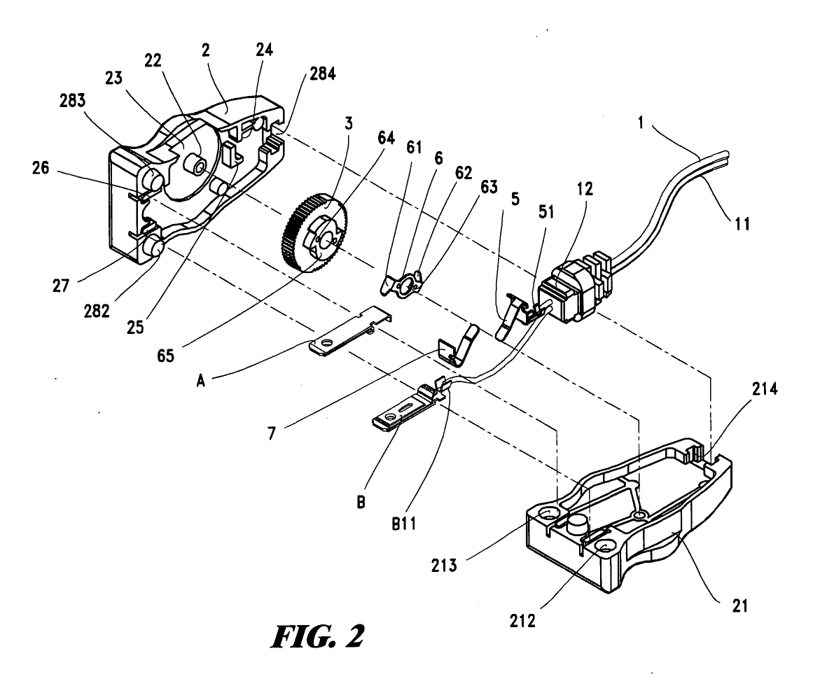

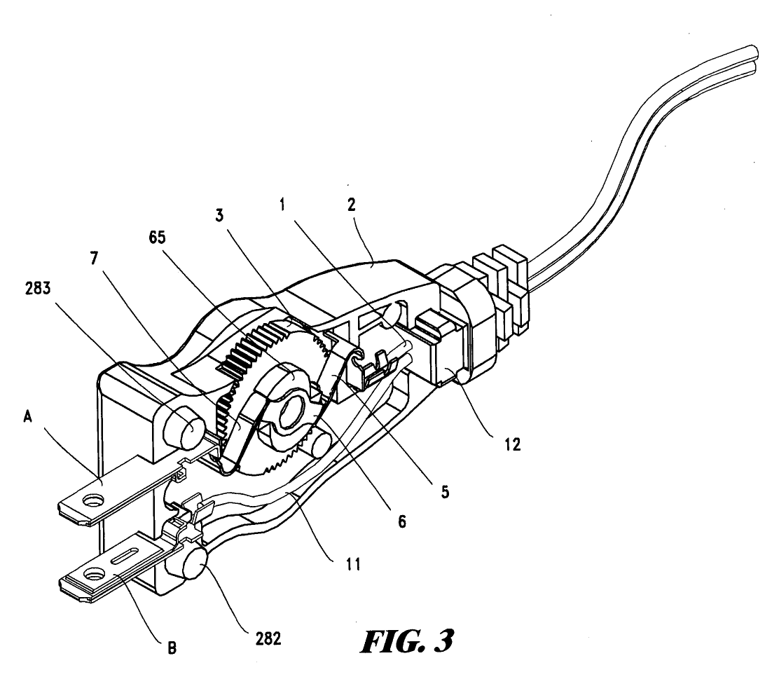

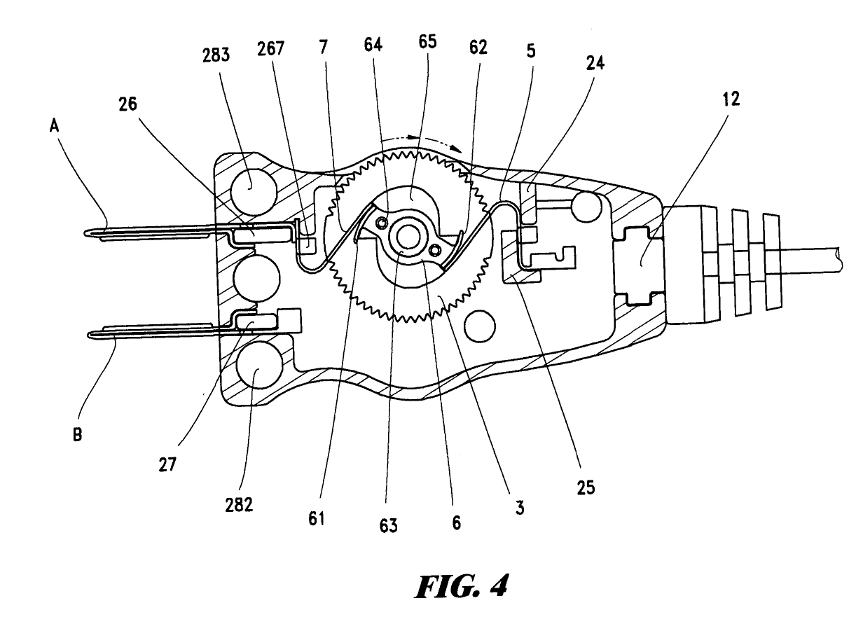

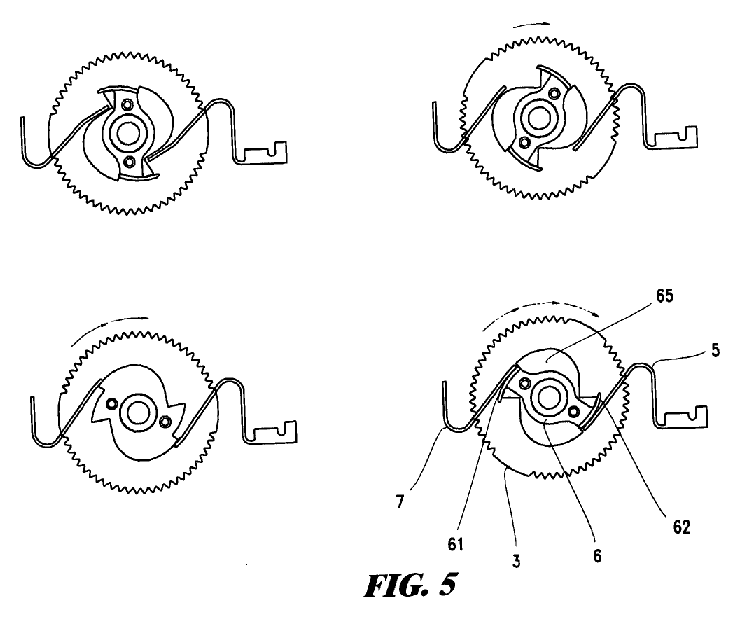

Please refer to FIG. 1 to FIG. 5. This invention is of the structure of a safety plug that is used to switch power in sequence easily and is composed of main body, upper housing, copper strip, flexible conductive strip, a wheel with a curved block on its lateral side, a conductive curve strip and wires. The main parts include a pair of wires for connection (1, 11), a main body (2), an upper housing (21), two copper strips (A and B) and a switch-gear (3). Integrating a screw and a nut, the upper housing is screwed tightly on the top of the main body. Meanwhile, the said screw is also a central axis of the said switch-gear so as to switch power supply easily.

The design of this invention is to that the wire is led to pass through the main body. The end of the wire (11) is riveted firmly on the joint point (B11) of the copper strip (B). The shorter wire (1) is riveted on the joint point (51) of the flexible conductive strip (5). The conductive part (6) is the conductive component with a pair of joint symmetrical curve strip (61 and 62) on its lateral sides. The fixing hole (63) of the said conductive component is fixed on the curved block (64) to fix the embedded switch-gear (3) on the curved block (65). The assembly is set inside the main body and fixed by aligning the hole of the switch-gear with the curved block (22) so that the outer ring of the switch-gear is revealing on the gap (23) of the outer ring of the main body (2). The wire (1) and the flexible conductive strip (5) are assembled within the main body and fixed between two curved blocks (24 and 25) so that the curved-end of the flexible conductive strip is precisely fitted on the top of the gear tooth of the switch-gear of the curved block and can be rotated easily. A pair of copper strip (A and B) is inserted into the holes in front of the main body and the ends of the said strips are fixed into two curved blocks (26 and 27). And, the curved section of the flexible conductive strips (7) is inserted into the gap between the third curved block located on the rear (267) of the first two curved blocks of the main body and the copper strip (A) in order to tighten the conductive strip with the end of the conductive strip for power supply. The curve end of the said flexible conductive strip is fixed precisely on the top of gear tooth of the curved block of the switch-gear and the flexible conductive strip can be controlled to flap through the strip body factors. The upper housing (21) is set on the top of the main body and there are two corresponding holes (212 and 213) in the front of the upper housing and a gap (214) in the rear of the upper housing. The upper housing is fixed on the main body (2) by fixing the holes and gap on the two cones (282 and 283) in the front of the main body and the fillister (284) in the rear of the main body. Then a nut is put on the hole (215) reserved and a screw passes through the center hole (22) of the housing from the bottom of the main body. Then the screw is screwed with the nut while the upper fillister and lower fillister (214 and 284) are assembled with a space between them. The space is for the wires (1 and 11) and the connection part (12) to be embedded and fixed within the housing to complete the assembly of the plug. Consequently, this invention is invented for easy power switch supply in sequence, so as to prevent the loosing plug by eliminating the frequent plug and unplug actions, and the danger of electric shock. Further, it is to ensure that the plug can provide an efficient power switch device with safety features and excellent conductive quality.

What is claimed is:

1. This invention is of the structure of safety plug that is used to switch power supply in sequence easily and is composed of the main body, upper housing, copper strip, flexible conductive strip, a wheel with a curved block on its lateral side, conductive curve strip and wires. The main parts include
the end of the wire is riveted firmly on the joint point of the said copper strip. The shorter wire is riveted on the joint point of the said flexible conductive strip. The conductive part is the conductive component with a pair of joint symmetrical curve strip on its lateral sides. The fixing hole of the conductive component is fixed on the curved block to fix the embedded switch-gear on the curved block. The assembly is set inside the main body and fixed by aligning the hole of the switch-gear with the curved block so that the outer ring of the switch-gear is revealing on the gap of the outer ring of the main body. The wire and the flexible conductive strip are assembled within the main body and fixed between two curved blocks so that the curved-end of the flexible conductive strip is precisely fitted on the top of the gear tooth of the switch-gear of the curved block and can be rotated easily. A pair of copper strip is inserted into the holes in front of the main body and the ends of the said strips are fixed into two curved blocks. And, the curved section of the flexible conductive strips is inserted into the third curved block located on the rear of the first two curved block of the main body to tighten the conductive strip with the end of the conductive strip for power supply. The curve end of the said flexible conductive strip is fixed precisely on the top of the gear tooth of the curved block of the switch-gear. Then the flexible conductive strip can be controlled to flap through the strip body factors. The upper housing is set on the top of the main body and there are two corresponding holes in the front of the upper housing and a gap in the rear of the upper housing. The upper housing is fixed on the main body by fixing the holes and gap on the two cones in the front of the main body and the fillister in the rear of the main body. Then a nut is put on the hole reserved and a screw passes through the center hole of the housing from the bottom of the main body. Then the screw is screwed with the nut while the upper fillister and lower fillister are assembled with a space between them. The space is for the wires and the connection part to be embedded and fixed within the housing to complete the assembly of the plug. Thus it is easy to switch power supply in sequence to improve the safety by protecting the plug. Consequently, this invention is invented for easy power switch supply in sequence, so as to prevent the loosing plug by eliminating the frequent plug and unplug actions, and the danger of electric shock. Further, it is to ensure that the plug can provide an efficient power switch device with safety features and excellent conductive quality.

2. As illustrated in the first section of the patent application, this is the structure of a safety plug that is used to switch power supply in sequence easily, especially for the structure that is designed so that when the switch-gear rotates in 360 degrees, the curved block will rotate simultaneously. Two corresponding curved blocks are used to control the rotation in order to connect the curve strip to the front and back conductive strips. There is a gap on the bottom of the curved blocks in order to increase the flexibility factor of the conductive strip's forward and reverse performance.
